(19) United States
(12) Patent Application Publication
(10) Pub. No.: US 2021/0031525 A1
(43) Pub. Date: Feb. 4, 2021

(54) LIQUID ABSORBER AND LIQUID EJECTION APPARATUS

(71) Applicant: SEIKO EPSON CORPORATION, Tokyo (JP)

(72) Inventors: Naotaka HIGUCHI, Suwa-gun (JP); Shogo NAKADA, Matsumoto (JP); Yoichi MIYASAKA, Suwa (JP)

(21) Appl. No.: 16/941,638

(22) Filed: Jul. 29, 2020

(30) Foreign Application Priority Data
Jul. 31, 2019 (JP) 2019-141202

(51) Int. Cl. B41J 2/165

(52) U.S. Cl. CPC B41J 2/16505

(57) ABSTRACT

A liquid absorber includes a liquid absorption member, a case, a cover member, and a filler member. The liquid absorption member absorbs at least a portion of a liquid. The liquid absorption member includes at least one of an assembly of fibers and an assembly of fiber substrates. The liquid absorption member is stored in the case. The cover member is coupled to the case. The filler member is disposed between the liquid absorption member and the cover member. The filler member is a member through which at least a portion of the liquid is to pass. A bulk density of the filler member is less than a bulk density of the liquid absorption member.

The present application is based on, and claims priority from JP Application Serial Number 2019-141202, filed Jul. 31, 2019, the disclosure of which is hereby incorporated by reference herein in its entirety.

### BACKGROUND

### 1. Technical Field

The present disclosure relates to a liquid absorber and a liquid ejection apparatus.

### 2. Related Art

In ink jet printers, waste ink is typically generated during a head cleaning operation, which is performed to prevent a reduction in printing quality due to nozzle clogging caused by the drying of ink, and during an ink filling operation after a replacement of an ink cartridge. To absorb waste ink, a liquid absorber including a liquid absorption member is used.

For example, JP-A-2014-188802 describes a liquid absorption member that absorbs liquid. The liquid absorption member is formed primarily of a fiber and includes a fused resin.

Unfortunately, in the liquid absorption member of JP-A-2014-188802, the individual fibers are fused to one another with a fused resin, and, therefore, the liquid absorption member needs to be processed to fit the shape of the case in which the liquid absorption member is to be stored. Thus, the liquid absorption member has low versatility and incurs high processing costs.

Correspondingly, the development of liquid absorption members that can conform to the shape of any desired case and can be provided at reduced processing costs is being advanced. Examples of such liquid absorption members include an assembly of crushed pieces or fibrillated cotton fibers.

However, with a liquid absorption member that conforms to the shape of any desired case, when an external impact due to, for example, falling of the container or transportation is applied, the crushed pieces or the fibrillated cotton fibers move and cause deformation or the like, and as a result, uneven distribution occurs within the container. In particular, in assemblies of crushed pieces, uneven distribution tends to occur. In a situation in which such uneven distribution has occurred, ensuring good absorption characteristics is difficult.

### SUMMARY

According to an aspect of the present disclosure, a liquid absorber includes a liquid absorption member, a case, a cover member, and a filler member. The liquid absorption member absorbs at least a portion of a liquid. The liquid absorption member includes at least one of an assembly of fibers and an assembly of fiber substrates. The liquid absorption member is stored in the case. The cover member is coupled to the case. The filler member is disposed between the liquid absorption member and the cover member. The filler member is a member through which at least a portion of the liquid is to pass. A bulk density of the filler member is less than a bulk density of the liquid absorption member.

According to another aspect, the liquid absorber may be as follows: the filler member may include a fiber.

According to another aspect, the liquid absorber may be as follows: the filler member may include a cellulose fiber.

According to another aspect, the liquid absorber may be as follows: the filler member and the liquid absorption member may include a liquid-absorbent resin.

According to another aspect, the liquid absorber may be as follows: a mass of the liquid-absorbent resin in the filler member per unit mass of the filler member may be less than a mass of the liquid-absorbent resin in the liquid absorption member per unit mass of the liquid absorption member.

According to another aspect, the liquid absorber may be as follows: the filler member may include small pieces, the small pieces including fiber substrates and the liquid-absorbent resin, and the liquid absorption member may include small pieces, the small pieces including fiber substrates and the liquid-absorbent resin.

According to another aspect, the liquid absorber may be as follows: an area of the small pieces of the filler member may be larger than an area of the small pieces of the liquid absorption member.

According to another aspect, the liquid absorber may be as follows: an aspect ratio of the small pieces of the filler member may be greater than an aspect ratio of the small pieces of the liquid absorption member.

According to another aspect, the liquid absorber may be as follows: the filler member may include a foam.

According to another aspect, the liquid absorber may be as follows: the filler member may include a material having a flame-retardant property or a self-extinguishing property.

According to another aspect, the liquid absorber may be as follows: the filler member may be bonded to the liquid absorption member.

According to an aspect of the present disclosure, a liquid ejection apparatus includes a liquid ejection head and the liquid absorber according to any of the aspects described above. The liquid absorber absorbs the liquid. The liquid is ejected from the liquid ejection head.

### BRIEF DESCRIPTION OF THE DRAWINGS

FIG. 1 is a schematic diagram of a liquid absorber according to an embodiment of the present disclosure.

FIG. 2 is a schematic diagram of the liquid absorber according to the embodiment.

FIG. 3 is a schematic perspective view of a small piece included in the liquid absorber, according to the embodiment.

FIG. 4 is a schematic cross-sectional view of a small piece included in the liquid absorber, according to the embodiment.

FIG. 5 is a diagram illustrating a method for producing the liquid absorber, according to the embodiment.

FIG. 6 is a diagram illustrating the method for producing the liquid absorber, according to the embodiment.

FIG. 7 is a diagram illustrating the method for producing the liquid absorber, according to the embodiment.

FIG. 8 is a schematic perspective view of a liquid absorber according to a first modified example of the embodiment.

FIG. 9 is a schematic cross-sectional view of the liquid absorber according to the first modified example of the embodiment.

FIG. 10 is a schematic plan view of a liquid absorber according to a second modified example of the embodiment.

FIG. 11 is a schematic cross-sectional view of the liquid absorber according to the second modified example of the embodiment.

FIG. 12 is a schematic cross-sectional view of the liquid absorber according to the second modified example of the embodiment.

FIG. 13 is a schematic cross-sectional view of a small piece included in a liquid absorber, according to a third modified example of the embodiment.

FIG. 14 is a diagram illustrating a method for producing the liquid absorber, according to the third modified example of the embodiment.

FIG. 15 is a diagram illustrating the method for producing the liquid absorber, according to the third modified example of the embodiment.

FIG. 16 is a schematic diagram of a liquid ejection apparatus according to an embodiment of the present disclosure.

FIG. 17 is a photograph of a filler member of Example 1.

FIG. 18 is a photograph of a filler member of Example 3.

FIG. 19 is a photograph of a filler member of Example 4.

FIG. 20 is a table showing the production conditions of Examples 1 to 9 and Comparative Example.

### DESCRIPTION OF EXEMPLARY EMBODIMENTS

Preferred embodiments of the present disclosure will now be described in detail with reference to the drawings. Note that the embodiments described below are not intended to unduly limit the content of the present disclosure described in the claims. Furthermore, not all of the configurations described below may be essential configuration requirements of the present disclosure.

### 1. LIQUID ABSORBER

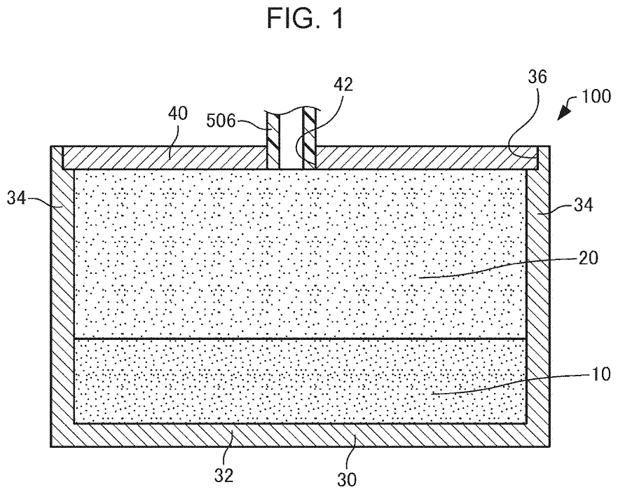

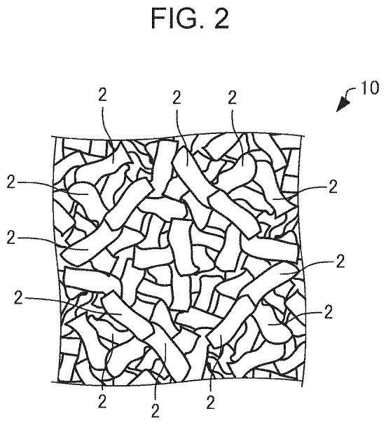

First, a liquid absorber according to an embodiment of the present disclosure will be described with reference to the drawings. FIG. 1 is a schematic diagram of a liquid absorber 100, according to an embodiment of the present disclosure. FIG. 2 is a schematic diagram of the liquid absorber 100 according to the embodiment. FIG. 2 is an enlarged view of a portion of a liquid absorption member 10, which is illustrated in FIG. 1.

As illustrated in FIG. 1, the liquid absorber 100 includes the liquid absorption member 10, a filler member 20, a case 30, and a cover member 40. In the following description, each of the elements will be described.

### 1. 1. Liquid Absorption Member

The liquid absorption member 10 absorbs liquid. Specifically, the liquid absorption member 10 absorbs inks, such as an aqueous ink in which a colorant is dissolved in an aqueous solvent, a solvent-based ink in which a binder is dissolved in a solvent, a UV (ultraviolet) curable ink in which a binder is dissolved in a liquid monomer and which is cured by UV irradiation, and a latex ink in which a binder is dispersed in a dispersion medium. The following description is made assuming that the liquid absorbed by the liquid absorption member 10 is ink.

### 1. 1. 1. Small Pieces

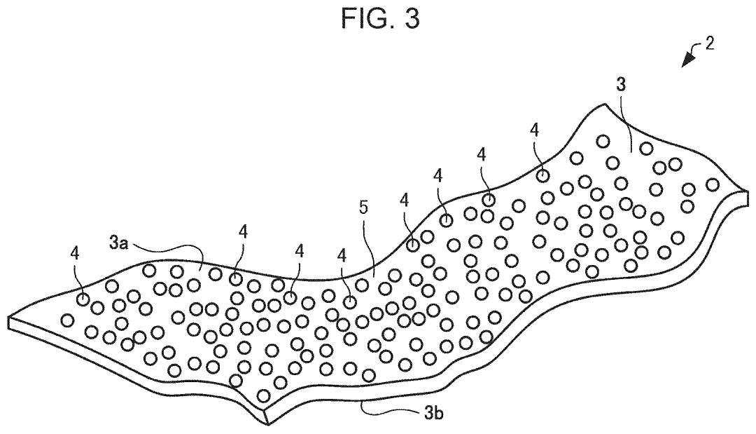

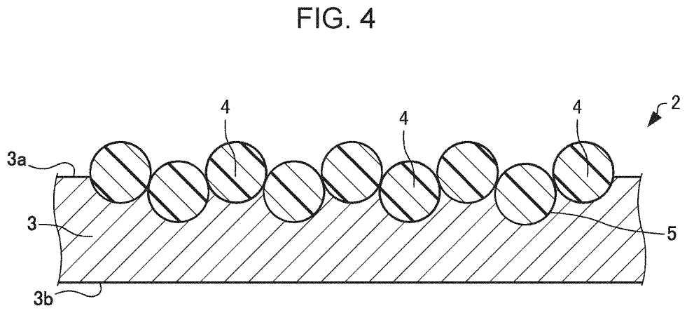

As illustrated in FIG. 2, the liquid absorption member 10 includes an assembly of small pieces 2, for example. The liquid absorption member 10 may be formed of small pieces 2. FIG. 3 is a schematic perspective view of a small piece 2. FIG. 4 is a schematic cross-sectional view of a small piece 2. Note that, in FIG. 1, the liquid absorption member 10 and the filler member 20 are illustrated in a simplified manner for convenience.

As illustrated in FIG. 3 and FIG. 4, the small piece 2 includes, for example, a fiber substrate 3 and a liquid-absorbent resin 4, which is supported on the fiber substrate 3.

It is preferable that the small pieces 2 be strip-shaped pieces having flexibility. With this configuration, the small pieces 2 can be easily deformed. Hence, when the liquid absorption member 10 is stored in the case 30, the liquid absorption member 10 is deformed regardless of the shape of the case 30 and, therefore, can be stored therein without difficulty.

A full length of the small pieces 2, that is, a length in a longitudinal direction of the small pieces 2, is preferably 0.5 mm or greater and 200 mm or less, more preferably 1 mm or greater and 100 mm or less, and even more preferably 2 mm or greater and 30 mm or less.

A width of the small pieces 2, that is, a length in a transverse direction of the small pieces 2, is preferably 0.1 mm or greater and 100 mm or less, more preferably 0.3 mm or greater and 50 mm or less, and even more preferably 1 mm or greater and 10 mm or less.

An area of the small pieces 2 is preferably 0.1 mm² or greater and 100 mm² or less, more preferably 0.3 mm² or greater and 30 mm² or less, and even more preferably 0.5 mm² or greater and 15 mm² or less.

An aspect ratio between the full length of the small pieces 2 and the width thereof is preferably 1 or greater and 200 or less and more preferably 1 or greater and 30 or less. A thickness of the small pieces 2 is preferably 0.05 mm or greater and 2 mm or less and more preferably 0.1 mm or greater and 1 mm or less. Note that the “area of the small pieces 2” and the “aspect ratio of the small pieces 2” are an area and an aspect ratio of a small piece 2 as viewed in a thickness direction of the small piece 2 in a state in which the small piece 2 has been pulled with a degree of force that does not tear the small piece 2 and thus stretched.

When the above-mentioned ranges are satisfied, the liquid-absorbent resin 4 can be suitably supported, ink can be suitably held in the fiber, and the ink can be suitably delivered to the liquid-absorbent resin 4; hence, the liquid absorption member 10 has excellent absorption characteristics with respect to ink. In addition, the liquid absorption member 10 can be easily deformed and, therefore, has improved conformability to the shape of the case 30.

For example, the small pieces 2 are stored in the case 30 randomly, without regularity, in a manner such that the longitudinal directions of the small pieces 2 do not extend parallel to one another but extend crosswise to one another. Thus, gaps can be easily formed between the small pieces 2. As a result, ink can flow through the gaps, and, when the gaps are very small, ink can wet and spread under capillary action. Accordingly, ink flowability is ensured. Hence, in the case 30, ink flowing downwardly is prevented from being blocked along the way, and as a result, the ink can penetrate to a bottom portion 32 of the case 30.

Since the small pieces 2 are stored randomly, the opportunity for the liquid absorption member 10 as a whole to come into contact with ink is increased, and, hence, the liquid absorption member 10 has excellent absorption characteristics with respect to ink. Furthermore, in the process of storing the liquid absorption member 10 into the case 30, the small pieces 2 can be thrown into the case 30 in a random manner, and, therefore, the operation can be carried out readily and quickly.

A bulk density of the liquid absorption member 10 is preferably 0.01 g/cm³ or greater and 0.50 g/cm³ or less, more preferably 0.03 g/cm³ or greater and 0.30 g/cm³ or less, and even more preferably 0.05 g/cm³ or greater and 0.20 g/cm³ or less. With such a bulk density, an ink retention and an ink penetration are both achieved.

### 1. 1. 2. Fiber Substrate

The fiber substrate 3 has a sheet shape. The fiber substrate 3 is formed of individual fibers. The liquid absorption member 10 includes an assembly of the fiber substrates 3. In the illustrated example, the liquid absorption member 10 includes an assembly of the fiber substrates 3, on which the liquid-absorbent resin 4 is supported.

Examples of the fiber that is included in the fiber substrate 3 include synthetic resin fibers, such as polyester fibers and polyethylene fibers, and natural resin fibers, such as cellulose fibers, keratinous fibers, and fibroin fibers.

It is preferable that the fiber included in the fiber substrate 3 be a cellulose fiber. Cellulose fibers are hydrophilic materials, and, therefore, when ink is provided to a cellulose fiber, the cellulose fiber can suitably take in the ink. In addition, the cellulose fiber can suitably deliver the ink that is taken temporarily to the liquid-absorbent resin 4. Hence, the liquid absorption member 10 has excellent absorption characteristics with respect to ink. Furthermore, cellulose fibers have a high affinity for the liquid-absorbent resin 4, and, therefore, a cellulose fiber can suitably support the liquid-absorbent resin 4 on a surface of the fiber. Furthermore, cellulose fibers are renewable natural materials and are inexpensive and readily available compared with various other fibers. As such, cellulose fibers are advantageous also from the standpoint of reducing the production cost, ensuring stable production, and reducing environmental impact, for example.

Note that it is sufficient that the cellulose fiber be a fibrous material containing, as a major component, cellulose included in a compound, and the compound may include hemicellulose and/or lignin in addition to cellulose.

An average length of the individual fibers is preferably 0.1 mm or greater and 7 mm or less, more preferably 0.1 mm or greater and 5 mm or less, and even more preferably 0.1 mm or greater and 3 mm or less. An average width of the individual fibers is preferably 0.5 μm or greater and 200 μm or less and more preferably 1.0 μm or greater and 100 μm or less. An average aspect ratio of the individual fibers is preferably 10 or greater and 1000 or less and more preferably 15 or greater and 500 or less. The average aspect ratio is the ratio of the average length to the average width.

When the above-mentioned ranges are satisfied, the liquid-absorbent resin 4 can be more suitably supported, ink can be more suitably held in the fiber, and the ink can be more suitably delivered to the liquid-absorbent resin 4; hence, the liquid absorption member 10 has excellent absorption characteristics with respect to ink.

### 1. 1. 3. Liquid-Absorbent Resin

As illustrated in FIG. 3 and FIG. 4, the particles of the liquid-absorbent resin 4 are supported on the fiber substrate 3. In the illustrated example, the particles of the liquid-absorbent resin 4 are supported only on one surface 3a of the fiber substrate 3. Although not illustrated, some or all of the particles of the liquid-absorbent resin 4 may be supported on another surface 3b of the fiber substrate 3.

As illustrated in FIG. 4, the particles of the liquid-absorbent resin 4 may be partially embedded in the one surface 3a of the fiber substrate 3. That is, the particles of the liquid-absorbent resin 4 may be partially enclosed in the fiber substrate 3. With this configuration, the ability of the fiber substrate 3 to support the liquid-absorbent resin 4 is increased. Hence, the liquid-absorbent resin 4 is prevented from falling off the fiber substrate 3. As a result, the liquid absorption member 10, which is formed of an assembly of the small pieces 2, exhibits excellent absorption characteristics with respect to ink over a long period of time. In addition, uneven distribution of the liquid-absorbent resin 4 in the case 30 is prevented.

Note that the particles of the liquid-absorbent resin 4 may not be partially embedded in the surface 3a of the fiber substrate 3. The particles of the liquid-absorbent resin 4 may be merely applied to the fiber substrate 3 and thus may merely adhere to the fiber substrate 3.

The liquid-absorbent resin 4 is a super absorbent polymer (SAP) having liquid absorbency properties. The term “liquid absorbency” refers to the ability to exhibit hydrophilicity and retain a liquid component. The liquid-absorbent resin 4 may be gelled as a result of absorption of liquid. Specifically, the liquid-absorbent resin 4 absorbs liquid present in ink, such as water and a hydrophilic organic solvent.

Examples of the liquid-absorbent resin 4 include carboxymethyl cellulose, polyacrylic acids, polyacrylamides, starch-acrylic acid graft copolymers, hydrolysates of starch-acrylonitrile graft copolymers, vinyl acetate-acrylic ester copolymers, isobutylene-maleic acid copolymers, hydrolysates of acrylonitrile copolymers or acrylamide copolymers, polyethylene oxide, polysulfonic acid compounds, polyglutamic acids, salts thereof, modified products thereof, and crosslinked products thereof.

It is preferable that the liquid-absorbent resin 4 be a resin including structural units that contain a functional group in a side chain. Examples of the functional group include acid groups, hydroxyl groups, epoxy groups, and amino groups. In particular, it is preferable that an acid group be present in the side chain of the resin, and it is more preferable that a carboxyl group be present in the side chain of the resin.

Examples of a carboxyl-group-containing unit that may be included in the side chain include units derived from a monomer such as acrylic acid, methacrylic acid, itaconic acid, maleic acid, crotonic acid, fumaric acid, sorbic acid, cinnamic acid, an anhydride of any of the foregoing acids, or a salt of any of the foregoing acids.

When the liquid-absorbent resin 4 is a resin including structural units that contain an acid group in a side chain, a percentage of acid groups of the liquid-absorbent resin 4 that are neutralized and form a salt, relative to the total moles of acid groups in the liquid-absorbent resin 4, is preferably 30 mol % or greater and 100 mol % or less, more preferably 50 mol % or greater and 95 mol % or less, even more preferably 60 mol % or greater and 90 mol % or less, and most preferably 70 mol % or greater and 80 mol % or less. Such a liquid-absorbent resin 4 has excellent absorption characteristics with respect to ink.

Examples of the neutralized salt include alkali metal salts, such as sodium salts, potassium salts, and lithium salts, and salts of a nitrogen-containing basic compound, such as ammonia. In particular, a sodium salt is preferable. Such a liquid-absorbent resin 4 has excellent absorption characteristics with respect to ink.

In a liquid-absorbent resin 4 including structural units that contain an acid group in a side chain, electrostatic repulsion occurs between acid groups during absorption of ink, which increases the absorption rate. Thus, such a liquid-absorbent resin 4 is preferable. Furthermore, in the instance in which acid groups are neutralized, ink can be easily absorbed into the liquid-absorbent resin 4 under osmotic pressure.

The liquid-absorbent resin 4 may have a structural unit in which no acid group is present in a side chain. Examples of such a structural unit include hydrophilic structural units, hydrophobic structural units, and structural units that serve as a polymerizable crosslinking agent.

Examples of the hydrophilic structural units include structural units derived from a nonionic compound, such as acrylamide, methacrylamide, N-ethyl (meth)acrylamide, N-n-propyl (meth)acrylamide, N-isopropyl (meth)acrylamide, N,N-dimethyl (meth)acrylamide, 2-hydroxyethyl (meth)acrylate, 2-hydroxypropyl (meth)acrylate, methoxypolyethylene glycol (meth)acrylate, polyethylene glycol mono(meth)acrylate, N-vinylpyrrolidone, N-acryloylpiperidine, or N-acryloylpyrrolidine.

Examples of the hydrophobic structural units include structural units derived from a compound such as (meth)acrylonitrile, styrene, vinyl chloride, butadiene, isobutene, ethylene, propylene, stearyl (meth)acrylate, or lauryl (meth)acrylate.

Examples of the structural units that serve as a polymerizable crosslinking agent include structural units derived from a compound such as diethyleneglycol diacrylate, N,N-methylenebisacrylamide, polyethylene glycol diacrylate, polypropylene glycol diacrylate, trimethylolpropane diallyl ether, trimethylolpropane triacrylate, allyl glycidyl ether, pentaerythritol triallyl ether, pentaerythritol diacrylate monostearate, bisphenol diacrylate, isocyanurate diacrylate, tetraallyloxyethane, or a salt of diallyloxyacetic acid.

It is preferable that the liquid-absorbent resin 4 include a polyacrylic acid salt copolymer or a crosslinked polyacrylic acid polymer. Such a liquid-absorbent resin 4 exhibits improved ink absorption performance and enables a reduction in production cost, for example.

In the crosslinked polyacrylic acid polymer, a percentage of carboxyl-group-containing structural units relative to the total moles of all the structural units included in the molecular chain is preferably greater than or equal to 50 mol %, more preferably greater than or equal to 80 mol %, and even more preferably greater than or equal to 90 mol %. If the percentage of the carboxyl-group-containing structural units is too low, it may be difficult to ensure a sufficiently good ink absorption characteristic.

It is preferable that some of the carboxyl groups in the crosslinked polyacrylic acid polymer be neutralized and form a salt. In the crosslinked polyacrylic acid polymer, a percentage of neutralized carboxyl groups relative to the total moles of all the carboxyl groups is preferably 30 mol % or greater and 99 mol % or less, more preferably 50 mol % or greater and 99 mol % or less, and even more preferably 70 mol % or greater and 99 mol % or less.

The liquid-absorbent resin 4 may include a crosslinked structure formed with a crosslinking agent other than the polymerizable crosslinking agent mentioned above.

When the liquid-absorbent resin 4 is a resin containing acid groups, it is preferable that the crosslinking agent be, for example, a compound containing acid groups and functional groups that are reactive with acid groups. When the liquid-absorbent resin 4 is a resin containing acid groups and functional groups that are reactive with acid groups, it is preferable that the crosslinking agent be a compound containing, in the molecule, functional groups that are reactive with acid groups.

Examples of the crosslinking agent containing acid groups and functional groups that are reactive with acid groups include glycidyl ether compounds, such as ethylene glycol diglycidyl ether, trimethylolpropane triglycidyl ether, (poly)glycerol polyglycidyl ether, diglycerol polyglycidyl ether, and propylene glycol diglycidyl ether; polyhydric alcohols, such as (poly)glycerol, (poly)ethylene glycol, propylene glycol, 1,3-propanediol, polyoxyethylene glycol, triethylene glycol, tetraethylene glycol, diethanolamine, and triethanolamine; and polyamines and the like, such as ethylenediamine, diethylenediamine, polyethyleneimine, and hexamethylene diamine. Other preferred examples include ions of a multivalent metal, such as zinc, calcium, magnesium, or aluminum. Such ions serve as a crosslinking agent by reacting with acid groups present in the liquid-absorbent resin 4.

The particles of the liquid-absorbent resin 4 may have any shape, such as flaky, acicular, fibrous, or substantially spherical or equiaxed, but it is preferable that most of the particles have a substantially spherical or equiaxed shape. When most of the particles of the liquid-absorbent resin 4 have a substantially spherical or equiaxed shape, an ink penetration can be easily ensured. In addition, the liquid-absorbent resin 4 can be suitably supported on the fiber. Note that the phrase “substantially spherical or equiaxed shape” refers to a shape having an aspect ratio of 0.3 or greater and 1.0 or less. The aspect ratio is the ratio of a minimum length of the particle to a maximum length thereof. An average particle diameter of the particles is preferably 15 μm or greater and 800 μm or less, more preferably 15 μm or greater and 400 μm or less, and even more preferably 15 μm or greater and 50 μm or less.

Note that the average particle diameter of the particles may be, for example, a mean volume diameter MVD, which is a volume-based mean particle diameter measured with a laser diffraction particle diameter distribution analyzer. Particle diameter distribution analyzers using the laser diffraction light scattering method as the measurement principle, that is, laser diffraction particle diameter distribution analyzers, can measure particle diameter distributions based on volume.

Preferably, a relationship of 0.15≤L/D≤467 is satisfied, more preferably, a relationship of 0.25≤L/D≤333 is satisfied, and even more preferably, a relationship of 2≤L/D≤200 is satisfied, where D is the average particle diameter [μm] of the liquid-absorbent resin 4, and L is the average length [μm] of the individual fibers.

In the liquid absorption member 10, a content of the liquid-absorbent resin 4 is preferably 25 mass % or greater and 300 mass % or less and more preferably 50 mass % or greater and 150 mass % or less, relative to a mass of the fiber. With such a content, a sufficient ink absorption characteristic and a sufficient ink penetration are ensured in the liquid absorption member 10.

If the content of the liquid-absorbent resin 4 is less than 25 mass % relative to the mass of the fiber, the liquid absorption characteristics may be insufficient. On the other hand, if the content of the liquid-absorbent resin 4 is greater than 300 mass % relative to the mass of the fiber, the liquid absorption member 10 may tend to swell when the liquid absorption member 10 absorbs ink, and as a result, the penetration may be reduced.

### 1. 1. 4. Adhesive

For example, the small pieces 2 include an adhesive 5, which bonds the liquid-absorbent resin 4 to the fiber substrates 3. Accordingly, the ability of the fiber substrates 3 to support the liquid-absorbent resin 4 is enhanced, which makes it unlikely that the liquid-absorbent resin 4 will fall off the fiber substrates 3. Note that the small pieces 2 may not include the adhesive 5.

Examples of the adhesive 5 include water-soluble adhesives and organic adhesives. In particular, a water-soluble adhesive is preferable. In instances in which an aqueous ink is used, even if a water-soluble adhesive adheres to a surface of the liquid-absorbent resin 4, the water-soluble adhesive dissolves when the ink comes into contact with the water-soluble adhesive. Thus, the adhesive 5 is prevented from interfering with the absorption of ink into the liquid-absorbent resin 4.

Example of the adhesive 5 include proteins, such as casein, soy protein, and synthetic protein; various starches, such as starch and oxidized starch; polyvinyl alcohols, which include polyvinyl alcohol and modified polyvinyl alcohols, such as cationic polyvinyl alcohols and silyl-modified polyvinyl alcohols; cellulose derivatives, such as carboxymethyl cellulose and methylcellulose; aqueous polyurethane resins; and aqueous polyester resins. In particular, a polyvinyl alcohol is preferable in terms of bonding force. With a polyvinyl alcohol, the bonding force between the fiber substrate 3 and the liquid-absorbent resin 4 is sufficiently enhanced.

In the liquid absorption member 10, a content of the adhesive 5 is preferably 1.0 mass % or greater and 70 mass % or less and more preferably 2.5 mass % or greater and 50 mass % or less, relative to the mass of the fiber. If the content of the adhesive 5 is less than 1.0 mass % relative to the mass of the fiber, it is impossible to sufficiently produce an effect of the presence of the adhesive 5. On the other hand, if the content of the adhesive 5 is too high, no further significant improvement in the ability to support the liquid-absorbent resin 4 can be achieved.

Note that the liquid absorption member 10 may include one or more of the following, for example: a surfactant, a lubricant, a defoamer, a filler, an anti-blocking agent, a UV absorber, a colorant, such as a pigment or a dye, a flame-retardant agent, and a flow improver.

### 1. 2. Filler Member

As illustrated in FIG. 1, the filler member 20 is disposed between the liquid absorption member 10 and the cover member 40. The filler member 20 fills a space between the liquid absorption member 10 and the cover member 40. In the illustrated example, a thickness of the filler member 20 is less than a thickness of the liquid absorption member 10. For example, the filler member 20 is disposed in contact with the liquid absorption member 10, the case 30, and the cover member 40. The filler member 20 is a member through which ink is to pass. The filler member 20 may absorb a portion of the ink.

Similarly to the liquid absorption member 10, the filler member 20 includes small pieces 2, for example. That is, the filler member 20 includes fiber substrates 3 that include a cellulose fiber. The filler member 20 may be formed of small pieces 2. The filler member 20 may include a liquid-absorbent resin 4.

A bulk density of the filler member 20 is less than a bulk density of the liquid absorption member 10. The bulk density of the filler member 20 is preferably 0.001 g/cm³ or greater and 0.20 g/cm³ or less, more preferably 0.01 g/cm³ or greater and 0.15 g/cm³ or less, and even more preferably 0.025 g/cm³ or greater and 0.12 g/cm³ or less. When the bulk density of the filler member 20 is within such a range, the space between the liquid absorption member 10 and the cover member 40 can be filled with a reduced weight of the filler member 20, as compared with the liquid absorption member 10, and, accordingly, uneven distribution of the small pieces 2 in the liquid absorption member 10 can be reduced.

In an instance in which the filler member 20 and the liquid absorption member 10 are each formed of small pieces 2, the small pieces 2 of the filler member 20 have an area larger than an area of the small pieces 2 of the liquid absorption member 10, for example. The area of the small pieces 2 of the filler member 20 is preferably 1 mm² or greater and 500 mm² or less, more preferably 10 mm² or greater and 300 mm² or less, and even more preferably 15 mm² or greater and 200 mm² or less.

An aspect ratio between a full length of the small pieces 2 of the filler member 20 and a width thereof is, for example, greater than the aspect ratio of the small pieces 2 of the liquid absorption member 10. The aspect ratio of the small pieces 2 of the filler member 20 is preferably 3 or greater and 300 or less and more preferably 10 or greater and 100 or less.

A mass of the liquid-absorbent resin 4 of the filler member 20 per unit mass of the filler member 20 is less than a mass of the liquid-absorbent resin 4 of the liquid absorption member 10 per unit mass of the liquid absorption member 10, for example. In the filler member 20, a content of the liquid-absorbent resin 4 is preferably 1 mass % or greater and 50 mass % or less and more preferably 5 mass % or greater and 25 mass % or less, relative to a mass of the fiber.

A basis weight of the fiber substrates 3 of the filler member 20 is preferably 30 g/m² or greater and 200 g/m² or less and more preferably 50 g/m² or greater and 150 g/m² or less. When the basis weight is greater than or equal to 30 g/m², the rigidity of the small pieces 2 of the filler member 20 is increased, and, therefore, a shape of the liquid absorption member 10 can be easily maintained.

The filler member 20 may be bonded to the liquid absorption member 10. The filler member 20 may be bonded to the liquid absorption member 10 with a bonding force of a water-soluble adhesive. For example, after the liquid absorption member 10 is stored in the case 30, a water-soluble adhesive solution may be applied to the liquid absorption member 10 from a side of an opening 36 of the case 30, and thereafter the filler member 20 may be stored in the case 30 to bring the filler member 20 into contact with the liquid absorption member 10. In this manner, the filler member 20 can be bonded to the liquid absorption member 10 with a bonding force of the water-soluble adhesive.

Example of the water-soluble adhesive include polyvinyl alcohols, which include polyvinyl alcohol and modified polyvinyl alcohols, such as cationic polyvinyl alcohols and silyl-modified polyvinyl alcohols; cellulose derivatives, such as carboxymethyl cellulose and methylcellulose; aqueous polyurethane resins; and aqueous polyester resins.

The filler member 20 may be bonded to the liquid absorption member 10 with an adhesive force of the liquid-absorbent resin 4. For example, instead of a water-soluble adhesive solution, water may be applied to the liquid absorption member 10 from the side of the opening 36, and, accordingly, the filler member 20 can be bonded to the liquid absorption member 10 with an adhesive force of the liquid-absorbent resin 4. The application of water to the liquid-absorbent resin 4 causes the liquid-absorbent resin 4 to swell and exhibit tackiness. Accordingly, the liquid-absorbent resin 4 exhibits an adhesive force.

The filler member 20 may include a material having a flame-retardant property. The material having a flame-retardant property may be a flame-retardant agent. Examples of a material of the flame-retardant agent include bromine compounds, phosphorus compounds, chlorine compounds, antimony compounds, metal hydroxides, nitrogen compounds, and boron compounds.

Examples of the bromine compounds include pentabromodiphenyl ether, octabromodiphenyl ether, decabromodiphenyl ether, hexabromocyclododecane, and hexabromobenzene. Examples of the phosphorus compounds include phosphoric acid esters and red phosphorus. Examples of the chlorine compounds include chlorinated paraffins. Examples of the antimony compounds include antimony trioxide and antimony pentoxide. Examples of the metal hydroxides include aluminum hydroxide and magnesium hydroxide. Examples of the nitrogen compounds include melamine cyanurate. Examples of the boron compounds include BestBoron and SOUFA.

In the filler member 20, a content of the flame-retardant agent is preferably 5 mass % or greater and 100 mass % or less and more preferably 10 mass % or greater and 80 mass % or less, relative to the mass of the fiber.

The filler member 20 may include a material having a self-extinguishing property. The material having a self-extinguishing property may be a self-extinguishing resin. Examples of the self-extinguishing resin include nylon 66, polycarbonates, and polyvinyl chlorides. In the filler member 20, a content of the self-extinguishing resin is preferably 5 mass % or greater and 100 mass % or less and more preferably 10 mass % or greater and 80 mass % or less, relative to the mass of the fiber. Note that the filler member 20 may include both a flame-retardant agent and a self-extinguishing resin.

### 1. 3. Case

As illustrated in FIG. 1, the liquid absorption member 10 and the filler member 20 are stored in the case 30. The case 30 includes a bottom portion 32 and four sidewall portions 34, for example. The bottom portion 32 has a quadrilateral plan-view shape, and the sidewall portions 34 are disposed along the respective sides of the bottom portion 32, for example. The case 30 has a shape in which the opening 36 is disposed in an upper portion. Note that the plan-view shape of the bottom portion 32 is not limited to a quadrilateral shape and may be, for example, a circular shape.

It is preferable that the case 30 have a degree of shape retainability such that a volume of the case 30 does not change by 10% or greater when an internal pressure or an external force acts on the case 30. With such a degree of shape retainability, the case 30 can maintain its shape even when the liquid absorption member 10 absorbs ink and swells and thereby causes the case 30 to receive a force from the liquid absorption member 10. As a result, the installation state of the case 30 is stabilized, and, consequently, the liquid absorption member 10 can absorb ink in a consistent manner.

For example, a material of the case 30 is a resin material, such as a cyclic polyolefin or a polycarbonate, or a metal material, such as aluminum or stainless steel.

### 1. 4. Cover Member

The cover member 40 is coupled to the case 30. The cover member 40 closes the opening 36 of the case 30. A shape of the cover member 40 is a plate shape, for example. An opening portion 42 is disposed in the cover member 40. A tube 506 can be coupled through the opening portion 42. The opening portion 42 is a through-hole that extends through the cover member 40 in a thickness direction thereof. When ink is to be discharged to the liquid absorber 100, the tube 506 is coupled through the opening portion 42 to discharge the ink through the tube 506.

A thickness of the cover member 40 is preferably 1 mm or greater and 20 mm or less and more preferably 2 mm or greater and 8 mm or less. Note that the cover member 40 is not limited to a plate-shaped cover member that satisfies a numerical range such as those mentioned above, and the cover member 40 may be a film-shaped cover member having a smaller thickness. In such a configuration, the thickness of the cover member 40 is preferably 10 μm or greater and less than 1 mm.

### 1. 5. Effects

The liquid absorber 100 has the following effects, for example.

The liquid absorber 100 includes the filler member 20 disposed between the liquid absorption member 10 and the cover member 40. The filler member 20 is a member through which ink is to pass. The bulk density of the filler member 20 is less than the bulk density of the liquid absorption member 10. As a result, in the liquid absorber 100, the shape of the liquid absorption member 10 can be easily maintained, and uneven distribution of the small pieces 2 in the liquid absorption member 10 can be reduced, compared with a configuration in which no filler member 20 is provided and a configuration in which the bulk density of the filler member 20 is greater than the bulk density of the liquid absorption member 10. Accordingly, the liquid absorber 100 has good absorption characteristics.

For example, when the volume of the case 30 is 600 cm³, and ink in an amount of 540 cm³, which is 90% of the volume of the case 30, is to be absorbed, 38 g of the liquid absorption member 10 is necessary. When the bulk density of the liquid absorption member 10 is 0.2 g/cm³, the volume of the liquid absorption member 10 is 190 cm³. Accordingly, a filling ratio of the liquid absorption member 10 with respect to the volume of the case 30 is 32%, and a space of 360 cm³ is left above the liquid absorption member 10. By filling the space with the filler member 20, movement of the liquid absorption member 10 can be inhibited, and, accordingly, the shape of the liquid absorption member 10 can be maintained.

Furthermore, for example, when the bulk density of the filler member 20 is greater than the bulk density of the liquid absorption member 10, the small pieces 2 of the filler member 20 can easily move into the liquid absorption member 10 when, for instance, vibrations occur during transportation and, as a result, can become mixed with the small pieces 2 of the liquid absorption member 10. Thus, it is difficult to maintain the shape of the liquid absorption member 10.

In addition, in the liquid absorber 100, since the bulk density of the filler member 20 is less than the bulk density of the liquid absorption member 10, the mass of the filler member 20 is small. Accordingly, the load applied to the liquid absorption member 10 by the filler member 20 is low. As a result, the filler member 20 is inhibited from, when the liquid-absorbent resin 4 has absorbed ink, interfering with the swelling of the liquid-absorbent resin 4. As described, the filler member 20 can serve as a buffer material when the liquid-absorbent resin 4 swells.

In addition, the liquid absorption member 10 has a reduced bulk density compared with a liquid absorption member formed by fusing together individual fibers with a fused resin, such as a thermoplastic resin, and, therefore, the liquid absorption member 10 has excellent absorption characteristics with respect to ink. Specifically, a large area of contact between ink and the fiber is ensured, and, therefore, the fiber can hold the ink temporarily. Subsequently, the ink can be delivered from the fiber to the liquid-absorbent resin 4. Accordingly, the liquid absorption member 10 has excellent absorption characteristics with respect to ink.

In addition, the liquid absorption member 10 has improved conformability to the shape of the case 30 compared with a liquid absorption member formed by fusing together individual fibers with a fused resin. Hence, the liquid absorption member 10 is highly versatile, and the production cost can be reduced.

In the liquid absorber 100, the filler member 20 includes a cellulose fiber. Accordingly, in the liquid absorber 100, the ink discharged from the tube 506 can be absorbed by the cellulose fiber of the filler member 20. Hence, the amount of ink that can be absorbed by the liquid absorber 100 as a whole is increased. In addition, the cellulose fiber becomes pliable when the cellulose fiber has absorbed ink, and as a result, the filler member 20 is inhibited from interfering with the swelling of the liquid-absorbent resin 4.

In the liquid absorber 100, the filler member 20 includes the liquid-absorbent resin 4. Accordingly, in the liquid absorber 100, a portion of the ink discharged from the tube 506 can be absorbed by the liquid-absorbent resin 4 of the filler member 20. Hence, the amount of ink that can be absorbed by the liquid absorber 100 is increased. In addition, the filler member 20 has a flame-retardant property.

In the liquid absorber 100, the filler member 20 includes the small pieces 2, which include the fiber substrates 3 and the liquid-absorbent resin 4. In the liquid absorber 100, the stiffness of the small pieces 2 is increased because of the presence of the liquid-absorbent resin 4. Thus, the shape of the liquid absorption member 10 can be reliably maintained by virtue of the filler member 20. In addition, since the stiffness of the small pieces 2 is increased, the ability of the filler member 20 to serve as a buffer material when the liquid-absorbent resin 4 swells is improved.

In the liquid absorber 100, the area of the small pieces 2 of the filler member 20 is larger than the area of the small pieces 2 of the liquid absorption member 10. Accordingly, in the liquid absorber 100, for example, the bulk density of the filler member 20 is less than the bulk density of the liquid absorption member 10, and, therefore, it is unlikely that some of the small pieces 2 of the filler member 20 will be mixed with the small pieces 2 of the liquid absorption member 10.

In the liquid absorber 100, the aspect ratio of the small pieces 2 of the filler member 20 is greater than the aspect ratio of the small pieces 2 of the liquid absorption member 10. Accordingly, in the liquid absorber 100, for example, the small pieces 2 of the filler member 20 can easily become entangled with one another, and, therefore, a shape of the filler member 20 can be maintained; as a result, it is unlikely that some of the small pieces 2 of the filler member 20 will be mixed with the small pieces 2 of the liquid absorption member 10.

In the liquid absorber 100, the filler member 20 includes a material having a flame-retardant property or a self-extinguishing property. Accordingly, the filler member 20 has a flame-retardant property or a self-extinguishing property.

In the liquid absorber 100, the filler member 20 is bonded to the liquid absorption member 10. Accordingly, in the liquid absorber 100, it is further unlikely that some of the small pieces 2 of the filler member 20 will move into the liquid absorption member 10.

### 2. METHOD FOR PRODUCING LIQUID ABSORBER

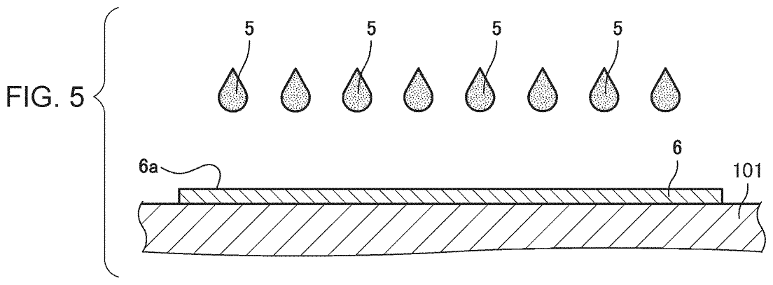

A method for producing the liquid absorber 100, according to the embodiment, will now be described with reference to the drawings. FIG. 5 to FIG. 7 are diagrams illustrating the method for producing the liquid absorber 100, according to the embodiment.

As illustrated in FIG. 5, a sheet-shaped sheet member 6 is laid on a bench 101. Examples of the sheet member 6 include PPC (plain paper copier) paper.

Next, an adhesive 5, which is in a liquid form, is applied to one surface 6a of the sheet member 6. Examples of a method for applying the adhesive 5 include a spray method and a method in which a sponge roller is impregnated with the adhesive 5, and the sponge roller is rolled across the surface 6a of the sheet member 6.

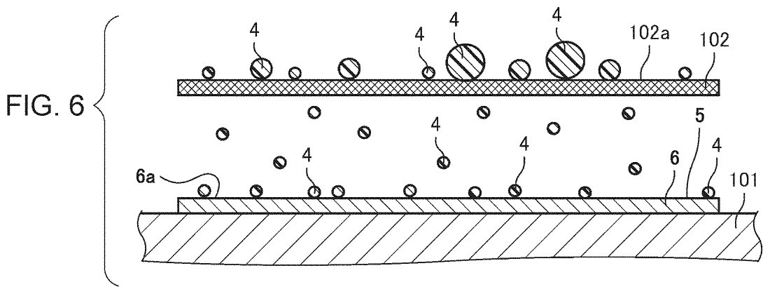

As illustrated in FIG. 6, particles of the liquid-absorbent resin 4 are applied to the surface 6a of the sheet member 6 through a mesh member 102. The mesh member 102 has openings 102a. Among the particles of the liquid-absorbent resin 4, particles larger than the openings 102a are retained on the mesh member 102, and particles smaller than the opening 102a pass through the openings 102a and are applied to the surface 6a of the sheet member 6.

Thus, the use of the mesh member 102 increases the uniformity of the particle diameters of the liquid-absorbent resin 4. Hence, variations in the absorption characteristics are prevented from occurring in different locations of the sheet member 6.

A maximum width of the openings 102a is preferably 0.06 mm or greater and 0.15 mm or less and more preferably 0.08 mm or greater and 0.12 mm or less. With this configuration, the particle diameters of the liquid-absorbent resin 4 applied to the sheet member 6 fall within the numerical range mentioned above.

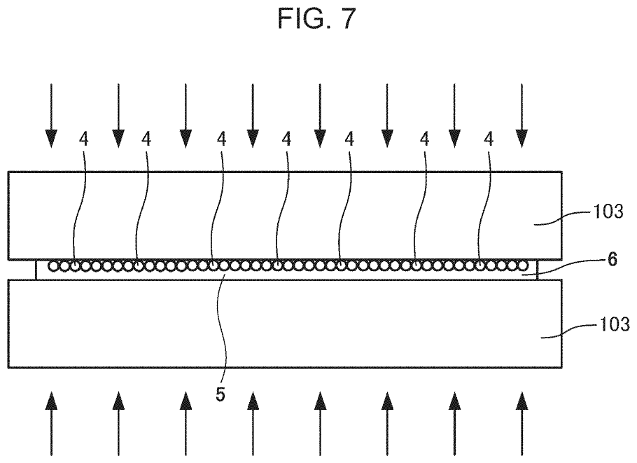

As illustrated in FIG. 7, the sheet member 6, to which the particles of the liquid-absorbent resin 4 adhere, is positioned between a pair of heating blocks 103. Subsequently, the pair of heating blocks 103 is heated, and pressure is applied to the pair of heating blocks 103 in a direction in which a distance between the heating blocks 103 decreases, thereby applying pressure to the sheet member 6 in a thickness direction thereof. Accordingly, the particles of the liquid-absorbent resin 4 and the adhesive 5 are softened, and the particles of the liquid-absorbent resin 4 become embedded in the sheet member 6 as a result of the application of pressure. Subsequently, the heating and pressure application are discontinued, and, accordingly, the adhesive 5 dries, and bonding is accomplished in a state in which the particles of the liquid-absorbent resin 4 are embedded in the sheet member 6.

In this step, the force of the pressure is preferably 0.1 kg/cm² or greater and 1.0 kg/cm² or less and more preferably 0.2 kg/cm² or greater and 0.8 kg/cm² or less. In this step, the heating temperature is preferably 80° C. or higher and 160° C. or lower and more preferably 100° C. or higher and 120° C. or lower.

Next, for example, the sheet member 6 is finely cut, crushed, or ground with scissors, a cutter, a mill, a shredder, or the like or, for example, finely torn by hand, to form small pieces 2. Next, a desired amount of the small pieces 2 are weighed out. Thereafter, the small pieces 2 are, for instance, loosened up by hand and stored in the case 30. In this manner, the liquid absorption member 10 made up of the small pieces 2 can be formed.

Next, the sheet member 6 is cut, crushed, or ground or finely torn by hand, to form small pieces 2 having a larger area than the small pieces 2 of the liquid absorption member 10, for example. Next, a desired amount of the small pieces 2 having a larger area are weighed out. Thereafter, the small pieces 2 are, for instance, loosened up by hand and stored in the case 30. In this manner, the filler member 20 made up of the small pieces 2 can be formed.

Next, as illustrated in FIG. 1, the opening 36 of the case 30 is sealed with the cover member 40. Specifically, the opening 36 of the case 30 is sealed with the cover member 40 by using any of the following methods, for example: a method in which the cover member 40 is a plastic molded article and is fitted to the case 30; a method in which the cover member 40 is a film and is fused to the case 30; and a method in which the cover member 40 is a mesh member and is fused to the case 30.

With the steps described above, the liquid absorber 100 can be produced.

### 3. MODIFIED EXAMPLES OF LIQUID ABSORBER

### 3. 1. First Modified Example

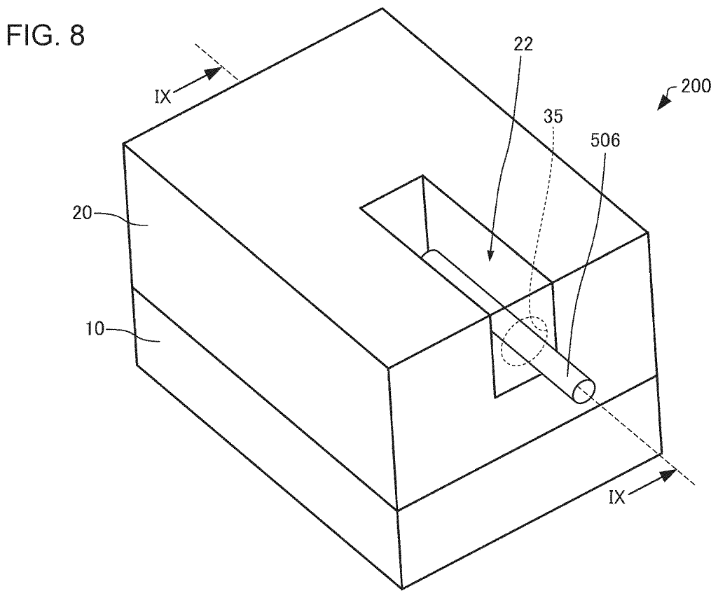

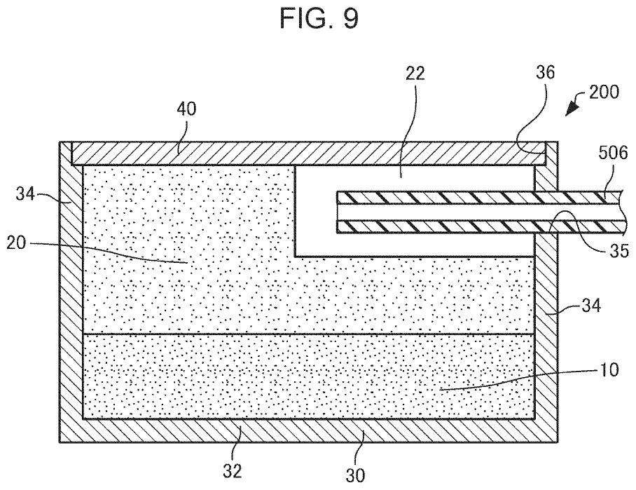

A liquid absorber according to a first modified example of the embodiment will now be described with reference to the drawings. FIG. 8 is a schematic perspective view of a liquid absorber 200, according to the first modified example of the embodiment. FIG. 9 is a schematic cross-sectional view, taken along line IX-IX of FIG. 8, of the liquid absorber 200 according to the first modified example of the embodiment. Note that, in FIG. 8, the case 30 and the cover member 40 are omitted for convenience.

In the following description, regarding the liquid absorber 200 according to the first modified example of the embodiment, components having a similar function to that of a corresponding structural component of the above-described liquid absorber 100 according to the embodiment are assigned the same reference character, and a detailed description thereof will be omitted. This applies to the descriptions of liquid absorbers of second and third modified examples of the embodiment, which will be described later.

In the liquid absorber 100 described above, the filler member 20 is formed of the small pieces 2.

In contrast, in the liquid absorber 200, the filler member 20 includes a foam. In the illustrated example, the filler member 20 is formed of a foam. That is, the filler member 20 is formed of a porous body having many fine pores. A size and a number of the pores of the foam are not particularly limited provided that the bulk density of the filler member 20 is less than the bulk density of the liquid absorption member 10. The foam may be a sponge.

Examples of a material of the foam to be included in the filler member 20 include urethane, polyethylene, chloroprene rubber, natural rubber, and styrene butadiene rubber.

Since the filler member 20 is formed of a foam, the filler member 20 has high compressibility. As a result, the filler member 20 is inhibited from, when the liquid-absorbent resin 4 has absorbed ink, interfering with the swelling of the liquid-absorbent resin 4.

Since the filler member 20 is formed of a foam, a shape of the filler member 20 can be easily maintained. Accordingly, as illustrated in FIG. 8 and FIG. 9, a cutout 22 can be formed in the filler member 20. The tube 506 can be inserted in the cutout 22. The cutout 22 enables smooth insertion of the tube 506 into the case 30. In addition, the cutout 22 prevents the tube 506 from being clogged as a result of contact of the tube 506 with the filler member 20.

In the example illustrated in FIG. 9, an opening portion 35 is disposed in a sidewall portion 34 of the case 30. The tube 506 is inserted through the opening portion 35.

### 3. 2. Second Modified Example

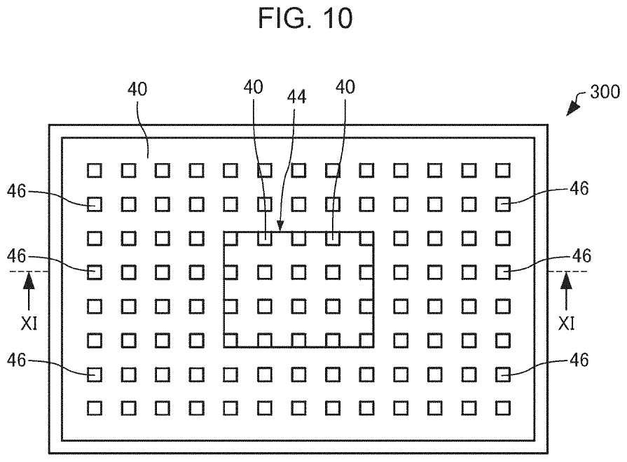

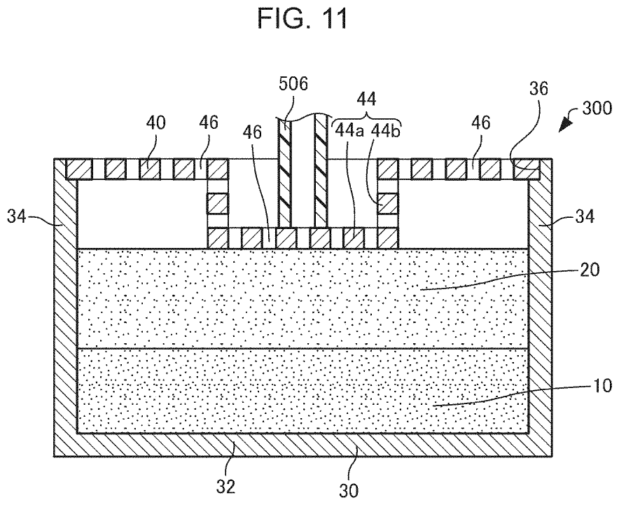

A liquid absorber according to a second modified example of the embodiment will now be described with reference to the drawings. FIG. 10 is a schematic plan view of a liquid absorber 300, according to the second modified example of the embodiment. FIG. 11 is a schematic cross-sectional view, taken along line XI-XI of FIG. 10, of the liquid absorber 300 according to the second modified example of the embodiment.

As illustrated in FIG. 10 and FIG. 11, the liquid absorber 300 is different from the above-described liquid absorber 100 in that the cover member 40 has a recessed portion 44.

The recessed portion 44 is recessed toward the filler member 20. The recessed portion 44 has a bottom portion 44a and sidewall portions 44b, which are coupled to the bottom portion 44a. The bottom portion 44a is in contact with the filler member 20. In the liquid absorber 300, the filler member 20 is restrained by the recessed portion 44, and as a result, uneven distribution of the small pieces 2 included in the filler member 20 can be reduced. In addition, the amount of the filler member 20 is reduced by an amount corresponding to the recessed portion 44.

The recessed portion 44 is disposed at a location to which ink is to be discharged. In plan view, the recessed portion 44 overlaps the tube 506. This configuration prevents ink from spilling to the outside during the discharging of the ink from the tube 506, which may otherwise occur due to formation of bubbles.

A through-hole 46 is disposed in the cover member 40. Ink can pass through the through-hole 46. The through-hole 46 extends through the cover member 40 in a thickness direction thereof. Thus, when the liquid absorption member 10 has absorbed ink, a liquid component of the ink can be evaporated through the through-hole 46. Accordingly, the absorbed ink can be easily dried.

The through-hole 46 is a plurality of through-holes 46. In the illustrated example, the through-holes 46 are disposed in the bottom portion 44a and the sidewall portions 44b of the recessed portion 44 and in portions of the cover member 40 other than the recessed portion 44. In the example illustrated in FIG. 10, the through-holes 46 are arranged in a matrix, in a first direction and in a second direction. The second direction is orthogonal to the first direction. A size of the through-holes 46 may be a size that does not allow the small pieces 2 of the liquid absorption member 10 and the small pieces 2 of the filler member 20 to pass through the through-holes 46. Such a size is sufficient.

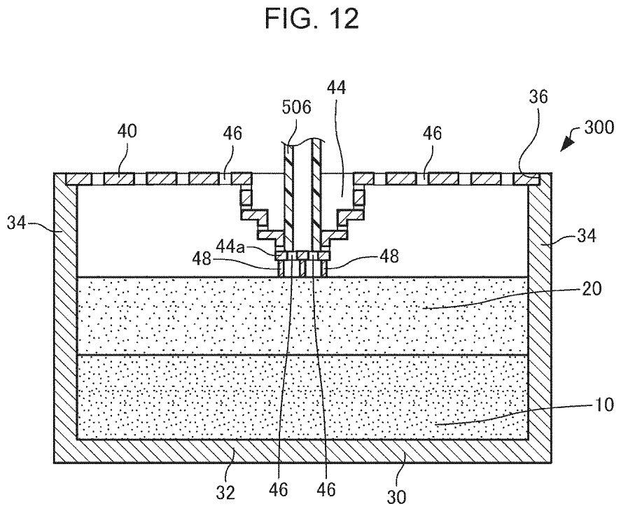

Note that, as illustrated in FIG. 12, the cover member 40 may include a projecting portion 48, which projects from the bottom portion 44a of the recessed portion 44 toward the filler member 20. The projecting portion 48 is a plurality of projecting portions 48. In the illustrated example, a distance between adjacent projecting portions 48 is greater than a width of an opening of the through-holes 46. The projecting portions 48 are in contact with the filler member 20. The bottom portion 44a of the recessed portion 44 is spaced from the filler member 20. This configuration inhibits through-holes 46 disposed in the bottom portion 44a from being clogged by the filler member 20.

### 3. 3. Third Modified Example

A liquid absorber according to a third modified example of the embodiment will now be described with reference to the drawings. FIG. 13 is a schematic cross-sectional view of a small piece 2 included in a liquid absorber 400, according to the third modified example of the embodiment.

As illustrated in FIG. 13, the liquid absorber 400 is different from the above-described liquid absorber 100 in that the liquid-absorbent resin 4 is held between a pair of the fiber substrates 3.

In the liquid absorber 400, the liquid-absorbent resin 4 is held between a pair of the fiber substrates 3, and, therefore, the liquid-absorbent resin 4 is unlikely to fall off the fiber substrates 3 compared with a configuration in which the liquid-absorbent resin 4 is not held between fiber substrates 3. Accordingly, excellent absorption characteristics with respect to ink are exhibited over a long period of time. In addition, uneven distribution of the liquid-absorbent resin 4 in the case 30 is prevented, and, therefore, variations in the ink absorption characteristics are prevented from occurring.

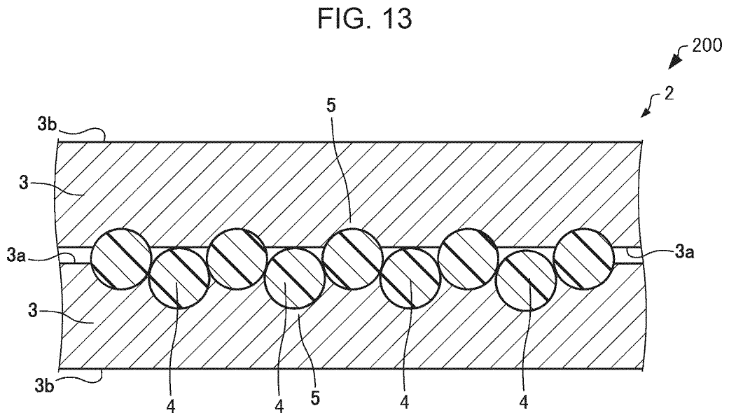

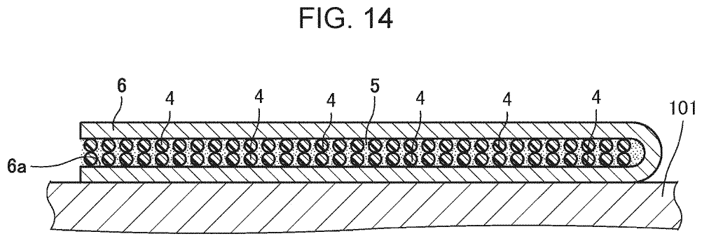

A method for producing the liquid absorber 400, according to the third modified example of the embodiment, will now be described with reference to the drawings. FIG. 14 and FIG. 15 are diagrams illustrating the method for producing the liquid absorber 400, according to the third modified example of the embodiment.

As illustrated in FIG. 14, particles of the liquid-absorbent resin 4 are applied to the sheet member 6 laid on the bench 101, and thereafter, the sheet member 6 is folded in a manner such that the surface 6a, which includes the applied particles of the liquid-absorbent resin 4, is located on the inner side.

As illustrated in FIG. 15, the folded sheet member 6 is positioned between the pair of heating blocks 103. Subsequently, the pair of heating blocks 103 is heated, and pressure is applied to the pair of heating blocks 103 in a direction in which a distance between the heating blocks 103 decreases, thereby applying pressure to the sheet member 6 in a thickness direction thereof. Accordingly, the particles of the liquid-absorbent resin 4 and the adhesive 5 are softened by the heat, and the particles of the liquid-absorbent resin 4 become embedded in the sheet member 6 as a result of the application of pressure. Furthermore, the particles of the liquid-absorbent resin 4 that come into contact with one another as a result of the folding are softened and joined together.

Subsequently, the heating and pressure application are discontinued, and, accordingly, the adhesive 5 dries, and bonding is accomplished in a state in which the particles of the liquid-absorbent resin 4 are embedded in the sheet member 6, and further, the folded halves of the sheet member 6, which overlap each other, are joined together with the particles of the liquid-absorbent resin 4 and the adhesive 5.

Next, the sheet member 6 is cut in a shredder or the like. The subsequent steps are basically the same as those of the method for producing the liquid absorber 100 described above.

In the method for producing the liquid absorber 400, the configuration including multilayers of the sheet member 6 is realized by the simple process, that is, by applying the liquid-absorbent resin 4 to a single sheet member 6 and folding the sheet member 6. That is, there is no need for the operation of applying the liquid-absorbent resin 4 to two sheet members 6 separately. Accordingly, the production process is simplified.

In addition, in the sheet member 6, the surface free of the liquid-absorbent resin 4 comes into contact with the heating blocks 103. Accordingly, adhering of the liquid-absorbent resin 4 to the heating blocks 103 is prevented. Hence, there is no need for a step of cleaning the heating blocks 103.

Note that in the example described above, the liquid absorption member 10 includes an assembly of the fiber substrates 3. Alternatively, in the liquid absorption member 10, the fibers may not constitute the fiber substrates 3, and, for example, individual fibers may be entangled with one another. The liquid absorption member 10 may include an assembly of such fibers. The assembly of such fibers may be a spunbond nonwoven fabric having a three-dimensional network structure.

Furthermore, the filler member 20 may include a spunbond nonwoven fabric having a three-dimensional network structure, as with the liquid absorption member 10. With this configuration, the cutout 22 can be formed in the filler member 20, as with the liquid absorber 200 described above. Since the filler member 20 having a three-dimensional network structure has a large void fraction, the filler member 20 is inhibited from, when the liquid-absorbent resin 4 of the liquid absorption member 10 has absorbed ink, interfering with the swelling of the liquid-absorbent resin 4.

Furthermore, the liquid absorption member 10 may include both an assembly of the fiber substrates 3 and an assembly of individual fibers that are entangled with one another. Similarly, the filler member 20 may include both an assembly of the fiber substrates 3 and an assembly of individual fibers that are entangled with one another.

### 4. LIQUID EJECTION APPARATUS

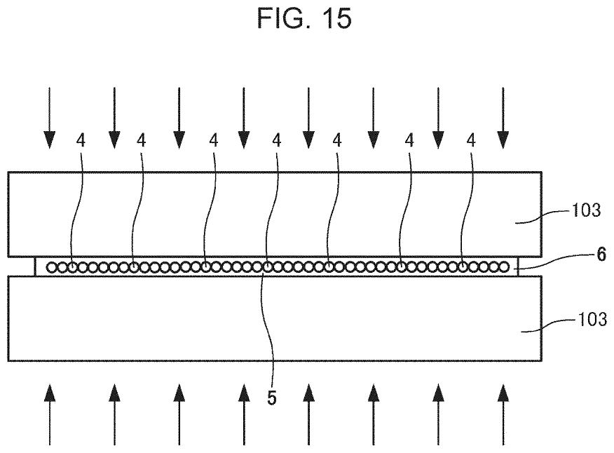

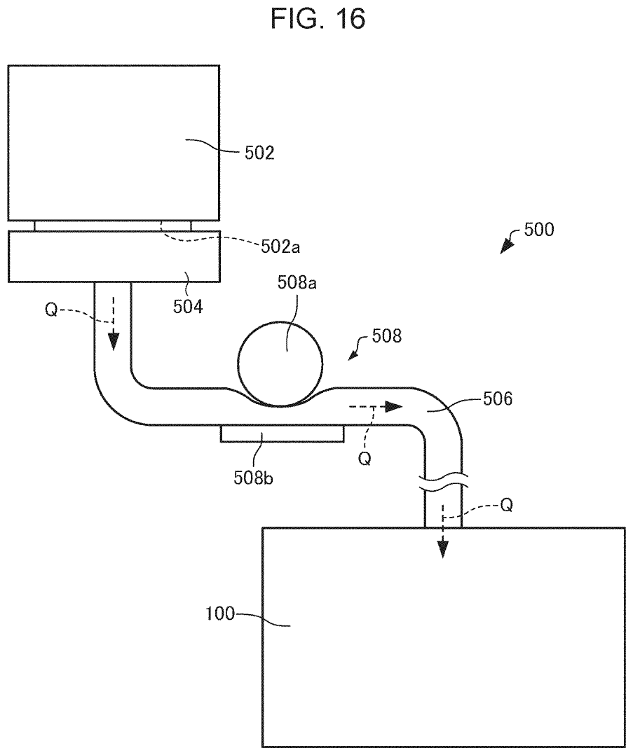

A liquid ejection apparatus according to an embodiment of the present disclosure will now be described with reference to the drawings. FIG. 16 is a schematic diagram of a liquid ejection apparatus 500, according to an embodiment of the present disclosure.

As illustrated in FIG. 16, the liquid ejection apparatus 500 includes, for example, a liquid ejection head 502, a capping unit 504, the tube 506, a roller pump 508, and the liquid absorber 100. The liquid ejection head 502 ejects an ink Q. The capping unit 504 prevents clogging of nozzles 502a of the liquid ejection head 502. The tube 506 couples the capping unit 504 to the liquid absorber 100. The roller pump 508 delivers the ink Q from the capping unit 504. The liquid absorber 100 collects waste liquid of the ink Q.

The liquid ejection head 502 includes nozzles 502a, through which the ink Q is ejected downwardly. The liquid ejection head 502 can perform printing on a recording medium (not illustrated), such as PPC paper, by moving relative to the recording medium and ejecting the ink Q onto the recording medium.

The capping unit 504 prevents clogging of the nozzles 502a in a manner such that when the liquid ejection head 502 is in standby position, the roller pump 508 is actuated to cause the capping unit 504 to apply suction collectively to the nozzles 502a.

The tube 506 allows the ink Q, which is sucked through the capping unit 504, to pass through the tube 506 to the liquid absorber 100. The tube 506 may have flexibility, for example.

The roller pump 508 is located at a portion along the tube 506. The roller pump 508 includes a roller member 508a and a holder member 508b, which holds the portion of the tube 506 with the roller member 508a. Rotation of the roller member 508a generates a suction force in the capping unit 504 via the tube 506. Further, continuous rotation of the roller member 508a enables the ink Q adhering to the nozzles 502a to be delivered to the liquid absorber 100. The ink Q is delivered to the liquid absorber 100 and absorbed as a waste liquid.

The liquid absorber 100 is attachably and detachably mounted to the liquid ejection apparatus 500. In a state in which the liquid absorber 100 is mounted to the liquid ejection apparatus 500, the liquid absorber 100 absorbs the ink Q, which is ejected from the liquid ejection head 502. The liquid absorber 100 is a so-called waste liquid tank. When the amount of absorbed ink Q in the liquid absorber 100 has reached a limit, the liquid absorber 100 can be replaced with a new, unused liquid absorber 100.

Note that whether the amount of absorbed ink Q in the liquid absorber 100 has reached a limit may be detected by a detector (not illustrated) of the liquid ejection apparatus 500. Furthermore, when the amount of absorbed ink Q in the liquid absorber 100 has reached a limit, a notification of the fact may be made by a notification unit, which may be a built-in monitor of the liquid ejection apparatus 500 or the like.

Note that liquid absorbers according to the present disclosure may also be used in applications other than liquid ejection apparatuses. For example, liquid absorbers according to the present disclosure may absorb waste liquid in applicator devices of the spray type, the dispensing type, or the like; the liquid absorbers may absorb waste liquid in aspiration systems for microbiology or cell culture; and the liquid absorbers may absorb leaking water or a leaking water-soluble solution in the event of a disaster or an accident. Liquid absorbers according to the present disclosure are capable of absorbing a large amount of waste liquid, and, when the liquid absorbers are to be disposed of, the mass of the liquid absorbers can be reduced by drying before disposal, that is, the liquid absorbers can be treated as solids with reduced environmental impact.

### 5. EXAMPLES AND COMPARATIVE EXAMPLE

### 5. 1. Preparation of Samples

### 5. 1. 1. Example 1

First, a liquid absorption member was prepared.

Specifically, water was applied to PPC paper G80 (A4 size, 4 g), manufactured by Toppan Forms Co., Ltd. Next, 3 g of a liquid-absorbent resin was applied to the PPC paper. The liquid-absorbent resin was Sanfresh ST-500MPSA, manufactured by Sanyo Chemical Industries, Ltd. The PPC paper was then folded in half in a manner such that the liquid-absorbent resin was located on the inner side. The resultant was dried in a heated press under the following conditions: 0.3 kg/cm², 100° C., and 2 minutes. Subsequently, the PPC paper was passed through a shredder twice. The shredder was capable of shredding paper into 2 mm×15 mm pieces. Thus, shredded pieces having an average size of 2 mm×15 mm were prepared. In the manner described above, a liquid absorption member was prepared.

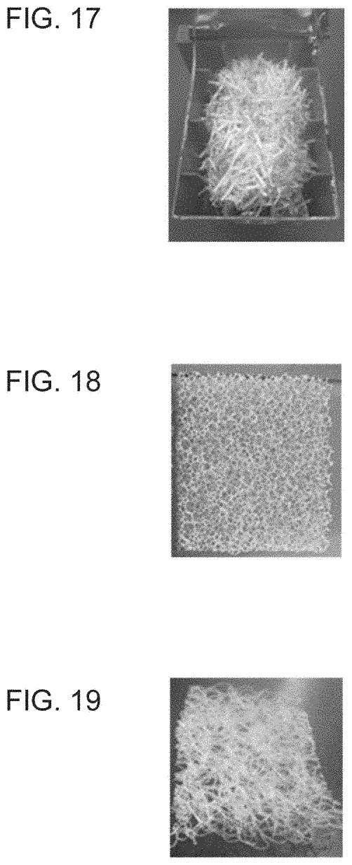

Next, PPC paper G80 (A4 size, 4 g, a basis weight of 64 g/m²), manufactured by Toppan Forms Co., Ltd., was cut in a shredder in a manner such that the resulting pieces had an average size of 2 mm×30 mm. Thus, a filler member was prepared. FIG. 17 is a photograph of the filler member of Example 1.

Next, 38 g of the liquid absorption member was placed in a 600-cm³ case and then vibrated using an electromagnetic sieve shaker AS200 digit, manufactured by Retsch, under the following conditions: an amplitude of 2.4 mm and 1 minute. Next, 25.2 g of the filler member was placed on the liquid absorption member, and vibration was similarly performed so that a total volume of the liquid absorption member and the filler member became 600 cm³.

### 5. 1. 2. Example 2

Example 2 was carried out as follows. The filler member was prepared in the following manner. Water was applied to PPC paper, and then 3 g of a liquid-absorbent resin was applied to the PPC paper. The liquid-absorbent resin was Sanfresh ST-500MPSA, manufactured by Sanyo Chemical Industries, Ltd. The PPC paper was then folded in half in a manner such that the liquid-absorbent resin was located on the inner side. The resultant was dried in a heated press under the following conditions: 0.3 kg/cm², 100° C., and 2 minutes. Subsequently, the PPC paper was cut in a manner such that the resulting pieces had an average size of 2 mm×30 mm. Thereafter, 43.2 g of the filler member was placed on the liquid absorption member. The steps other than the steps just described were similar to those of Example 1, described above.

In Example 2, the filler member included a liquid-absorbent resin, and as a result, it was confirmed that the filler member satisfied the UL-94HB flammability standard.

### 5. 1. 3. Example 3

Example 3 was similar to Example 1, described above, except that as the filler member, 10.8 g of urethane sponge UMF-8, manufactured by Fuji Gomu Co., Ltd., was placed on the liquid absorption member. FIG. 18 is a photograph of the filler member of Example 3.

### 5. 1. 4. Example 4

Example 4 was similar to Example 1, described above, except that as a filler member having a three-dimensional network structure, 9 g of Kurebulker (made of polyethylene, a bulk density of 0.03 g/cm³), manufactured by Kureha Ltd., was placed on the liquid absorption member. FIG. 19 is a photograph of the filler member of Example 4.

### 5. 1. 5. Example 5

Example 5 was carried out as follows. After the liquid absorption member was placed in the case, 20 cc of a 10 mass % aqueous PVA (polyvinyl alcohol) solution was applied, by spraying, to the surface of the liquid absorption member, and thereafter 36 g of the filler member was placed on the liquid absorption member. Subsequently, the resultant was allowed to stand for 1 hour at 60° C. and 20% RH (relative humidity). Thus, with the PVA, the surface of the liquid absorption member was solidified, and a portion of the filler member was bonded to a portion of the liquid absorption member. The steps other than the steps just described were similar to those of Example 1, described above.

### 5. 1. 6. Example 6

Example 6 was carried out as follows. After the liquid absorption member was placed in the case, 10 cc of pure water was applied, by spraying, to the surface of the liquid absorption member, and thereafter 28.8 g of the filler member was placed on the liquid absorption member. In addition, 10 cc of pure water was applied, by spraying, to the surface of the filler member. Subsequently, the resultant was allowed to stand for 1 hour at 60° C. and 20% RH. Thus, with the liquid-absorbent resin, which had absorbed the pure water and swollen, the surface of the liquid absorption member was solidified, and a portion of the filler member was bonded to a portion of the liquid absorption member. The steps other than the steps just described were similar to those of Example 1, described above.

### 5. 1. 7. Example 7

Example 7 was carried out as follows. The filler member was prepared in the following manner. 2 g/A4 of a flame-retardant agent Nonnen 600, manufactured by Marubishi Oil Chemical Co., Ltd., was applied to PPC paper, and the PPC paper was dried. Subsequently, the PPC paper was cut in a shredder in a manner such that the resulting pieces had an average size of 2 mm×30 mm, and then 32.4 g of the filler member was placed on the liquid absorption member. The steps other than the steps just described were similar to those of Example 1, described above.

In Example 7, the filler member included a flame-retardant agent, and as a result, it was confirmed that the filler member satisfied the UL-94HB flammability standard.

### 5. 1. 8. Example 8

Example 8 was similar to Example 1, described above, except that as the paper for the filler member, high-quality paper OK Prince (a basis weight of 104 g/m²), manufactured by Oji Paper Co., Ltd., was used, and 43.2 g of the filler member was placed on the liquid absorption member.

### 5. 1. 9. Example 9

Example 9 was carried out as follows. The filler member was prepared in the following manner. Water was applied to PPC paper, and then 3 g of a liquid-absorbent resin was applied to the PPC paper. The liquid-absorbent resin was Sanfresh ST-500MPSA, manufactured by Sanyo Chemical Industries, Ltd. The PPC paper was then folded in half in a manner such that the liquid-absorbent resin was located on the inner side. The resultant was dried in a heated press under the following conditions: 0.3 kg/cm², 100° C., and 2 minutes. Subsequently, the PPC paper was cut in a manner such that the resulting pieces had an average size of 2 mm×60 mm. Thereafter, 14.4 g of the filler member was placed on the liquid absorption member. The steps other than the steps just described were similar to those of Example 1, described above.

### 5. 1. 10. Comparative Example

Comparative Example was similar to Example 1, described above, except that no filler member was placed on the liquid absorption member.

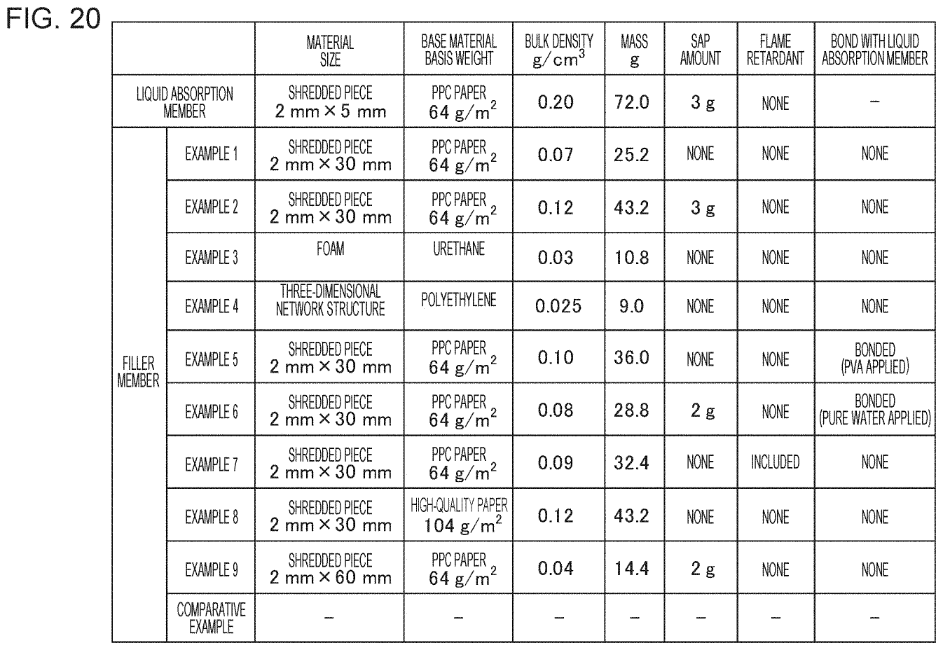

FIG. 20 is a table showing the production conditions of Examples 1 to 9 and Comparative Example. Note that, in FIG. 20, the bulk density is a value determined by dividing the mass of the liquid absorption member or the filler member by the volume of the liquid absorption member or the filler member, the volume being a volume after vibration was performed using an electromagnetic sieve shaker AS200 digit, manufactured by Retsch, under the conditions of an amplitude of 2.4 mm and 1 minute as described above. Furthermore, in Examples 1 to 9, the case having a volume of 600 cm³ was filled with the liquid absorption member or the filler member.

### 5. 2. Evaluation

In Examples 1 to 9, in which the bulk density of the filler member was less than the bulk density of the liquid absorption member, uneven distribution of the shredded pieces of the liquid absorption member was inhibited compared with Comparative Example.

In the present disclosure, one or more elements may be omitted, and various embodiments and/or modified examples may be combined together, as long as the features and effects described in the present application are retained.

The present disclosure is not limited to the embodiments described above, and various other modifications may be made. For example, the present disclosure includes configurations substantially identical with the configurations described in the embodiments. The substantially identical configurations are, for example, configurations in which functions, methods, and results are identical or configurations in which objects and effects are identical. Furthermore, the present disclosure includes configurations in which one or more non-essential elements of the configurations described in the embodiments are replaced with different elements. Furthermore, the present disclosure includes configurations that produce an effect identical with that of the configurations described in the embodiments or configurations that make it possible to achieve an object identical with that of the configurations. Furthermore, the present disclosure includes configurations in which one or more elements of the known art are added to any of the configurations described in the embodiments.

What is claimed is:

1. A liquid absorber comprising:
a liquid absorption member that absorbs at least a portion of a liquid, the liquid absorption member including at least one of an assembly of fibers and an assembly of fiber substrates;
a case in which the liquid absorption member is stored;
a cover member coupled to the case; and
a filler member disposed between the liquid absorption member and the cover member, the filler member being a member through which at least a portion of the liquid is to pass, wherein
a bulk density of the filler member is less than a bulk density of the liquid absorption member.

2. The liquid absorber according to claim 1, wherein the filler member includes a fiber.

3. The liquid absorber according to claim 1, wherein the filler member includes a cellulose fiber.

4. The liquid absorber according to claim 1, wherein the filler member and the liquid absorption member include a liquid-absorbent resin.

5. The liquid absorber according to claim 4, wherein a mass of the liquid-absorbent resin in the filler member per unit mass of the filler member is less than a mass of the liquid-absorbent resin in the liquid absorption member per unit mass of the liquid absorption member.

6. The liquid absorber according to claim 4, wherein
the filler member includes small pieces, the small pieces including fiber substrates and the liquid-absorbent resin, and
the liquid absorption member includes small pieces, the small pieces including fiber substrates and the liquid-absorbent resin.

7. The liquid absorber according to claim 6, wherein
an area of the small pieces of the filler member is larger than an area of the small pieces of the liquid absorption member.

8. The liquid absorber according to claim 6, wherein
an aspect ratio of the small pieces of the filler member is greater than an aspect ratio of the small pieces of the liquid absorption member.

9. The liquid absorber according to claim 1, wherein
the filler member includes a foam.

10. The liquid absorber according to claim 1, wherein
the filler member includes a material having a flame-retardant property or a self-extinguishing property.

11. The liquid absorber according to claim 1, wherein
the filler member is bonded to the liquid absorption member.

12. A liquid ejection apparatus comprising:
a liquid ejection head; and
the liquid absorber according to claim 1, the liquid absorber being an absorber that absorbs the liquid, the liquid being ejected from the liquid ejection head.
